(19) United States
(12) Patent Application Publication
(10) Pub. No.: US 2015/0356733 A1
(43) Pub. Date: Dec. 10, 2015

(54) MEDICAL IMAGE PROCESSING

(71) Applicant: KONINKLIJKE PHILIPS N.V., EINDHOVEN (NL)

(72) Inventors: OCTAVIAN SOLDEA, KIRYAT-BIALIK (IL); GERARDO SANTIAGO FLORES, EINDHOVEN (NL); RADU SERBAN JASINSCHI, NUENEN (NL)

(21) Appl. No.: 14/762,908

(22) PCT Filed: Jan. 16, 2015
(86) PCT No.: PCT/IB2014/058321

§ 371 Date: Jul. 23, 2015

Related U.S. Application Data
(60) Provisional application No. 61/757,289, filed on Jan. 28, 2013.

(51) Int. Cl. G06T 7/00

(52) U.S. Cl. CPC G06T 7/0014; G06T 7/0081; G06T 2207/30004; G06T 2207/30196; G06T 2207/10072; G06T 2207/10116; G06T 2207/10132

(57) ABSTRACT

An apparatus for processing of medical images comprises a (101) receiver for receiving a an image representing characteristics of a part of a human or animal body. The image may for example be a magnetic resonance or computer tomography image. A signature unit (103) determines an image associated set of signatures from the first image. A sample store (109) comprises a data base in the form of a set of samples where each sample comprises a sample associated set of signatures and medical data. A matching unit (105) determines a set of matching samples from the set of samples in response to a comparison of the image associated set of signatures to the sample associated sets of signatures of the set of samples. A decision unit (111) then determines medical data for the image in response to the medical data comprised in the samples of the set of matching samples.

### FIELD OF THE INVENTION

The invention relates to processing of medical images of a part of the human or animal body, and in particular, but not exclusively to processing of Magnetic Resonance Imaging (MRI) images.

### BACKGROUND OF THE INVENTION

Image processing of digital images is becoming increasingly important and widespread. Indeed, as processing power becomes increasingly powerful and cost effective, a large number of image processing applications are becoming attractive. In particular, in the last decades, image processing has become increasingly beneficial and widespread in the medical field where it may assist in various aspects of research, diagnosis and treatment. This has been further exacerbated by the advent of more complex means of generating images. Indeed, in the medical field, images are not limited to just being a capture of a visual scene (i.e. of light) but may also be generated from other sensory inputs. For example, two dimensional or even three dimensional images may be generated from ultrasound scanning or x-ray imaging. Another important image source in the medical field is Magnetic Resonance Imaging (MRI) which detects properties of Nuclear Magnetic Resonance (NMR) of nuclei of atoms inside the body. The detection of these properties allows detailed two or three dimensional images of internal parts of the body to be generated. For example, it allows detailed images reflecting the activities in the brain to be created.

However, a substantial issue in such new techniques is the complexity and difficulty in interpreting the images by a skilled professional. In order to assist this process, image processing is increasingly performed. Such image processing may simply consist in algorithms and approaches that improve the visual expression of the image, such as e.g. highlighting of specific image objects, contrast enhancement etc. However, other algorithms have been developed which seeks to assist in providing medical data extracted from the images. Such algorithms may specifically be based on comparisons of the image under investigation to a data base of stored images with associated data.

A significant challenge and typically limiting factor for such systems is the raw processing power which is required for the operations. Indeed, the images may typically be represented by huge amounts of data. For example, single three dimensional MRI image may be more than 500 MB of data. Comparing such an image with a large number of correspondingly large reference images requires enormous processing power. This not only increases equipment cost but also introduces delay in the processing and typically significantly limits the size of the data base that can be searched.

Hence, an improved approach would be advantageous and in particular an approach allowing increased flexibility, reduced cost, increased efficiency, reduced computational resources usage, generation of more accurate or reliable medical data and/or improved performance would be advantageous.

### SUMMARY OF THE INVENTION

Accordingly, the Invention seeks to preferably mitigate, alleviate or eliminate one or more of the above mentioned disadvantages singly or in any combination.

According to an aspect of the invention there is provided an apparatus for image processing, the apparatus comprising: a receiver for receiving a first image representing characteristics of a part of a human or animal body; a signature unit determining an image associated set of signatures from the first image, a sample store for storing a set of samples, each sample comprising a sample associated set of signatures and medical data; a matching unit for determining a set of matching samples from the set of samples in response to a comparison of the image associated set of signatures to the sample associated sets of signatures of the set of samples; and a decision unit arranged to determine medical data for the first image in response to the medical data comprised in the samples of the set of matching samples.

The invention may allow improved image processing of a medical image. In many embodiments, the invention may facilitate and/or improve e.g. computer facilitated interpretation and analysis of medical images. Indeed, in many embodiments, the invention may allow automatic generation of medical data for the image. In some applications, the image processing may assist a health professional in determining a diagnosis and/or treatment for a patient.

The approach may in particular allow a more efficient extraction of relevant medical data from a data base, and may for example substantially reduce the computational resource requirement for identifying relevant data. This may for example allow larger data bases to be utilized thereby allowing improved medical data to be produced. The approach may in many scenarios provide a more efficient storage of medical information, and may in particular allow an efficient storage of image information, thereby reducing the memory requirement, which may again allow larger data bases to be employed.

The approach may in many embodiments allow for a very efficient communication between different functional units, and may require reduced communication bandwidth for interconnecting data paths. This may for example allow different functions to be remotely located from each other, and may allow individual optimization when implementing the different functional units.

The approach may allow or enable distributed processing and may in particular allow networked processing. For example, part of the functionality, such as the generation of signatures, may be located conveniently for a user whereas the data base and comparison functionality may be located remotely. As the data amount that needs to be exchanged can be reduced substantially due to the use of signatures, such an approach can be implemented using many existing communication networks, including for example the Internet. The approach may also allow or facilitate a centralized structure where e.g. a central common data base and comparison functionality can support a plurality of distributed user stations.

The first image may be any signal or data collection providing a visual representation of a parameter or combination of parameters. The first image need not be a capture of visual characteristics but may be a visual representation of non-visible properties. For example, the first image may be an x-ray image or an image generated from magnetic resonance scanning. A signature may be an indication of a property of, or derived from, the image. The image associated set of signatures may typically be represented by less data than used to represent the image. Typically, the data size of the image associated set of signatures is at least ten times lower than the data size of the image. Signatures are typically (very) compact representations of specific image properties which are typically considered to be important for further image processing, search and retrieval, and diagnosis

Each sample may be a data collection comprising the image associated set of signatures for that sample. In addition each sample data collection may comprise associated medical data. The medical data may be indicative of a medical condition or illness.

The set of matching samples may contain only one matching sample in some situations. The set of matching samples may comprise the samples from the set of samples for which the image associated set of signatures and the sample associated sets of signatures meet a match criterion.

In some embodiments, the apparatus for image processing may provide an automated system which based on the first image automatically can search through a large data base of similar images to find images that exhibit very similar characteristics. The medical data stored for these matching images can then be extracted and e.g. output to a health professional.

In accordance with an optional feature of the invention, at least some signatures of the image associated set of signatures are local signatures representing local image information.

This may provide particularly advantageous signature indicative of characteristics with particular correlation to medical conditions. Each of the local signatures may allow at least a partial reconstruction of a local image area in many embodiments.

In accordance with an optional feature of the invention, the signature unit is arranged to divide the first image into a plurality of image segments; and wherein the signature unit comprises a parallel processor having a plurality of processing elements each of which is arranged to process a subset of the image segments to determine local signatures for the image segments.

This may provide a particularly efficient processing and may in many embodiments speed up the generation of signatures substantially. The system is particularly suited for segmented processing and for parallel processing. In particular, the system is particularly suitable for part processing by e.g. low cost Graphical Processing Units (GPUs), such as e.g. GPUs used for computer graphics processing.

In accordance with an optional feature of the invention, the division into image segments is not dependent on image properties of the first image.

This may reduce complexity and computational resource usage in many embodiments. In some applications, it may also be particularly suitable for determining signatures that are particularly good indicators for various medical conditions. For example, it may be suitable for determining local densities of abnormalities in the first image.

In accordance with an optional feature of the invention, the signature unit is further arranged to determine an image segment size for the image segments in response to image properties of the first image.

This may be advantageous in some embodiments and may in particular allow improved adaptation of the processing to the specific characteristics of the specific image.

In accordance with an optional feature of the invention, the matching unit comprises a parallel processor having a plurality of parallel processing elements each of which is arranged to compare at least one signature of the image associated set of local signatures to at least one signature of the sample associated sets of signatures.

This may provide a particularly efficient processing and may in many embodiments speed up the comparison very substantially. The system is particularly suited for parallel processing. In particular, the system is particularly suitable for part processing by e.g. low cost Graphical Processing Units (GPUs), such as e.g. GPUs used for computer graphics processing.

Image comparison is traditionally a very complex process that requires huge amounts of computational resource especially for large images as is often encountered for medical images. The approach may allow a substantial reduction in the comparison complexity and resource usage, and in addition a very large improvement in the computation time can be achieved by the approach being highly suitable for parallel processing. This may e.g. enable the implementation of a system where relevant medical data can be provided directly within a reasonable time frame. This may further allow larger data bases to be used, and thus may improve the quality/relevance of the generated medical data.

In accordance with an optional feature of the invention, the signature unit is implemented in a first processing unit and the matching unit is implemented in a separate second processing unit coupled to the first processor via a bandwidth limited communication link.

This may facilitate implementation in many embodiments. For example, the apparatus may be implemented by a Central Processing Unit (CPU) coupled to a GPU via a bandwidth limited link. The data that needs to be communicated between the units can be reduced substantially thereby making such an arrangement feasible in practice. In many embodiments, the bandwidth of the bandwidth limited communication link may be no more than 1 Mbit/s or 10 Mbit/s.

In accordance with an optional feature of the invention, the signature unit is arranged to generate a plurality of local signatures, each local signature representing local image information, and to generate at least one signature of the image associated set of signatures from a plurality of local signatures.

This may allow improved signatures with more medical relevance to be generated in many embodiments. The signature(s) generated from the local signatures may be local signatures but may in many scenarios not be local signatures, and indeed may in some scenarios be global signatures reflecting characteristics of the entire first image. The signatures may be combinations of signatures that are distributed spatially in body organs or of different types.

The approach may allow a more efficient detection of relevant samples and thus improved generation of medical data.

In accordance with an optional feature of the invention, the at least one signature represents a statistic measure for the plurality of local signatures.

This may allow improved signatures with more medical relevance to be generated in many embodiments. The approach may allow a more efficient detection of relevant samples and thus improved generation of medical data. The statistic measure may for example include an average, a variance, a histogram etc.

In accordance with an optional feature of the invention, the at least one signature represents a correlation measure of at least two local signatures.

This may allow improved signatures with more medical relevance to be generated in many embodiments. The approach may allow a more efficient detection of relevant samples and thus improved generation of medical data.

In accordance with an optional feature of the invention, the apparatus further comprises: an image object detector for detecting at least one image object in the first image; and the signature unit is arranged to determine at least one signature of the image associated set of signatures in response to a property of the image object.

This may allow improved signatures with more medical relevance to be generated in many embodiments. The approach may allow a more efficient detection of relevant samples and thus improved generation of medical data. For example, the approach may allow the signatures to increasingly reflect specific events or features, such as e.g. tracer components, a suspected tumor etc.

A signature may be generated based only on one image object and/or may be generated based on a plurality of image objects.

In accordance with an optional feature of the invention, the property of the at least one image object is at least one of: an object boundary property for the at least one image object; an area of the at least one image object; a volume of the at least one image object; a pose for the at least one image object; a position for the at least one image object; an orientation of the at least one image object; a luminance property for the at least one image object; a chromaticity property for the at least one image object; and a texture property of the at least one image object.

These features may in many scenarios provide signatures with more medical relevance to be generated in many embodiments. The approach may allow a more efficient detection of relevant samples, and thus improved generation of medical data. The features may individually or in combination directly be used as a signature.

In accordance with an optional feature of the invention, the at least one signature is determined in response to a moment of the first image object.

This may allow improved signatures with more medical relevance to be generated in many embodiments. The approach may allow a more efficient detection of relevant samples and thus improved generation of medical data.

In accordance with an optional feature of the invention, the signature unit is arranged to determine at least one signature of the image associated set of signatures in response to a comparison of the property to a reference.

This may allow improved signatures with more medical relevance to be generated in many embodiments. The approach may allow a more efficient detection of relevant samples and thus improved generation of medical data.

In particular, the reference may represent a value or interval which can be expected for the property for a healthy human or animal, and the signature may be generated to reflect how much the property deviates from the normal value(s) for the property. Such deviations may provide a particularly relevant indication for finding medical data that is relevant for the current images.

In accordance with an optional feature of the invention, the signature unit is arranged to determine at least one signature in response to a statistical deviation of an image property relative to a reference property for a plurality of image objects.

This may allow improved signatures with more medical relevance to be generated in many embodiments. The approach may allow a more efficient detection of relevant samples and thus improved generation of medical data.

In accordance with an optional feature of the invention, the apparatus further comprises a user interface for receiving a user input, and the signature unit is arranged to determine at least one signature of the image associated set of signatures in response to the user input.

This may allow improved generation of signatures in many embodiments and may accordingly provide improved generation of medical data particularly relevant for the first image.

In accordance with an optional feature of the invention, signatures of the sample associated set of signatures for at least some samples represent image properties of associated images of a part of a human or animal body.

The samples may be generated from medical images, and specifically may be generated from medical images from other patients. The signatures may be signatures extracted from these images using the same approach as for the first image. The medical data for a sample or image may for example be a related medical condition or illness that has been manually entered.

In accordance with an optional feature of the invention, the first image is at least one of: a Magnetic Resonance Imaging image, a Computer Tomography image, a

Positron Emission Tomography image, a Single-Photon Emission computed Tomography image; an ultrasound, image; an x-ray image; and a digital pathology histological image.

In accordance with an optional feature of the invention, at least one signature of the image associated set of signatures provides a wavelet representation of a property of the image.

This may provide a particularly advantageous signature for comparison in many embodiments. In particular, it may allow a compact representation of image properties while maintaining visual appearance information in the signature.

In accordance with an optional feature of the invention, the signature unit is arranged to detect image objects meeting a criterion, at least one signature of the image associated set of signatures is generated in response to a local density variation of the image objects meeting the criterion.

This may for many medical conditions and illnesses provide a particularly effective indicator thereby allowing improved detection of relevant samples and ultimately improved medical data to be generated.

In accordance with an optional feature of the invention, the apparatus further comprises an update processor for modifying the set of samples in response to the image associated set of signatures.

This may e.g. allow the data base of samples to continuously be improved thereby allowing a continuous improvement in the medical data which is generated.

In accordance with an optional feature of the invention, the first image is a three-dimensional image.

In accordance with an optional feature of the invention, the signature unit and the matching unit are coupled via a communication network

This may provide a particularly efficient implementation and/or user experience in many scenarios. It may for example allow a large central data base to be used from a plurality of positions.

According to an aspect of the invention there is provided a method of image processing, the method comprising: receiving a first image representing characteristics of a part of a human or animal body; determining an image associated set of signatures from the first image, providing a set of samples, each sample comprising a sample associated set of signatures and medical data; determining a set of matching samples from the set of samples in response to a comparison of the image associated set of signatures to the sample associated sets of signatures of the set of samples; and determining medical data for the first image in response to the medical data associated with the set of matching samples.

These and other aspects, features and advantages of the invention will be apparent from and elucidated with reference to the embodiment(s) described hereinafter.

### BRIEF DESCRIPTION OF THE DRAWINGS

Embodiments of the invention will be described, by way of example only, with reference to the drawings, in which

FIG. 1 illustrates an example of a medical imaging system in accordance with some embodiments of the invention;

FIG. 2 illustrates an example of architectures of a Central Processing Unit and a Graphical Processing Unit;

FIG. 3 illustrates illustrates the standard procedure for the diagnosis of Alzheimer's disease;

FIG. 4 illustrates an example of a medical imaging system in accordance with some embodiments of the invention;

FIG. 5 illustrates an example of a two-dimensional image of an ex-vivo patho-histological sample with Amyloid-Beta 42 staining;

FIG. 6 illustrates an example of 7T T2-weighted coronal MRI scans of a healthy individual;

FIG. 7 illustrates an example of a 7T T2-weighted coronal MRI scans of a diseased individual;

FIG. 8 illustrates an example of moments of a two-dimensional image object;

FIG. 9 illustrates an example of a histogram of moments of a two-dimensional image object;

FIG. 10 illustrates an example of generation of signatures for an image in accordance with some embodiments of the invention;

FIG. 11 illustrates an example of a spatial distribution of image objects in a medical image;

FIG. 12 illustrates an example of a medical imaging system in accordance with some embodiments of the invention; and

FIG. 13 illustrates an example of a graphical user interface for a medical imaging system in accordance with some embodiments of the invention.

### DETAILED DESCRIPTION OF SOME EMBODIMENTS OF THE INVENTION

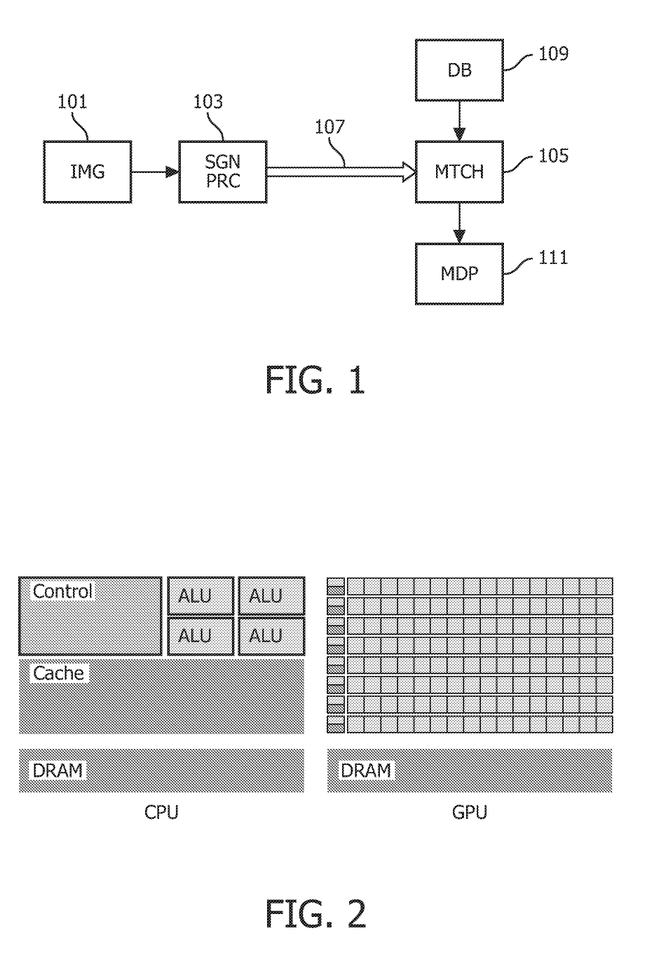

FIG. 1 illustrates an example of a medical imaging system in accordance with some embodiments of the invention.

The system comprises an image receiver 101 which receives a medical image which is to be processed by the system. The image is an image which represents a characteristic or property of a part of a human or animal body. The image may for example be of an organ or part of an organ of a human or animal. Indeed, in many embodiments, the image processing apparatus may be used as part of a treatment or diagnosis of a patient which suffers or is suspected of suffering a specific illness or condition. Thus, in many practical applications the image may be an image of a particular area of the body of a patient.

The image is typically a visual representation of a property of the part of the human body. In the medical field a large number of techniques have been developed to visualize internal parts of the human body, and specifically techniques have been developed that allows variations and abnormalities in the constituents of the body parts to be visualized.

For example, Magnetic Resonance Imaging has been developed to create images representing the variations in the magnetic resonance of atoms making up the body parts. An MRI apparatus creates a strong magnetic field to which different atoms react differently. These differences are detected and are used to generate an image of the internal part of the body.

As another example, Computer Tomography (CT) images may be generated where computer technology is used to generate images representing slices of the human body. CT can provide similar images to MRI. However; MRI tends to provide much higher brightness contrast of organ tissue (water molecules, etc.) properties.

Other examples of medical images include Positron Emission Tomography (PET) images where images are generated by detecting radiation from a radioactive tracer, Single-Photon Emission Computed Tomography (SPECT) images which are also based on detecting radiation from a radioactive tracer; ultrasound, images generated from detections of reflections of ultrasound; x-ray images which are generated from detections of x-rays passing through the subject under test; and digital pathology histological images which are images based on detecting microscopic features in an image suitable for digital processing.

The approach described may be applicable to all of these imaging techniques, and indeed to any other suitable medical imaging technique.

The image may be a two dimensional image but may also in many scenarios and applications be a three dimensional image. Indeed, many of the above reference medical image techniques inherently generate three dimensional images. The images may specifically be color or greyscale images.

The images may be provided in any suitable form, and may specifically be digital images provided in accordance with a suitable image representation standard.

A challenge for many medical imaging techniques is how to extract the optimum medical information and reach the best conclusions possible based on such data. For example, making a correct diagnosis based on medical images may be difficult in many scenarios and there may often be a certain risk involved when performing only a human analysis. Indeed, improved medical data can be extracted from medical images by not only considering the image itself but also considering existing information from similar images. For example, by comparing the current medical image to a large database of e.g. thousands of recorded images, it may be possible to find images with characteristics that resemble characteristics of the current image. In such cases, the medical information related to such images may be useful in analyzing the current image, and may for example be used to provide additional image data to a health practitioner (e.g. to a doctor) which facilitates or enables him to draw conclusions from the medical image.

The system of FIG. 1 is capable of performing such image processing and analysis.

However, a significant problem for medical imaging is that many of the generated images are extremely large. Indeed, in order to allow small details to be detectable, yet cover a sufficient part of the human body, it is required that the resolution is low and that the image is large resulting in a large amount of data being generated for each picture. This problem is significantly exacerbated for three dimensional images. For example, a typical 7 Tesla MRI three dimensional image may have a resolution of 800 by 800 by 700 voxels and have a size of about 750 Mbytes.

In the system of FIG. 1, a very effective processing of even large medical images is enabled or facilitated thereby allowing a medical image processing system which may automatically or semi-automatically provide medical data for the medical images.

The medical image is fed to a signature processor 103 which is arranged to generate a first set of signatures associated with the image (i.e. an image associated first set of signatures). Such signatures may provide a compact representation of one or more characteristics of the image or part of the image. For example, the signature processor 103 may divide the medical image into a number of blocks and then generate a signature for each block. For example, a signature corresponding to a luminance variance in each block may be generated.

The signature processor 103 is coupled to a match processor 105, and in the specific example the signature processor 103 and the match processor 105 are not only separate functional unit but also physically separate processing entities that are coupled via a data bus 107 with limited bandwidth. The signature processor 103 feeds the first set of signatures to the match processor 105 via the data bus 107.

In many embodiments, the data bus 107 has a bandwidth limitation which makes it impractical to communicate the full medical image across within a reasonable time. Therefore, the communication of the first set of signatures may allow a substantial compression in the data rate required by the data bus.

The match processor 105 is coupled to a sample store 109 which comprises a large database. The sample store 109 specifically comprises a set of samples with which the received signature can be compared. Each sample is a data collection comprising data describing at least a set of signatures as well as medical data.

In many embodiments, each of the samples may correspond to information from a medical image for which signatures have been created and for which medical data has been recorded. Thus, the set of signatures for a sample may represent image properties for a medical image which has previously been processed. The signatures provide a compact representation of characteristics of the original images and may e.g. be considered to be a representation of features of the original images which are particularly suitable for characterizing medical characteristics of the images. For example, signatures may be generated which represent a spatial distribution of the density of abnormal cells. Thus, the sample may represent image characteristics of the original image which have particular medical significance. In addition to the signatures, each sample contains medical data which is linked to the signatures. For example, medical data indicating the illness or condition suffered by the test person from whom the original image was generated may be stored in the sample.

As a specific example, the stored medical data may include Brain MRI images of healthy age matched controls, of patients with a neurodegenerative disease thus exhibiting focal atrophy, enlarged ventricles, reduced brain tissue parenchyma; the shape and location of pre-segmented body organs or their sub-parts as seen in MRI, CT, or PET images; patho-histological image of diseases, e.g., cancerous cells, endogenous (metals) abnormal deposits, e.g., iron etc.

The match processor 105 is arranged to compare the first set of signatures (i.e. the image associated set of signatures for the current image) to the sets of signatures for the different samples, Based on the comparisons a set of matching samples is detected. In some embodiments, the set of matching samples may be limited to only a single sample, i.e. the match processor 105 may select the best matching sample, but in most embodiments the matching sample set may comprise a plurality of samples. In many embodiments, the number of matching samples may vary from image to image. For example, the set of matching samples may be generated to include all samples for which a measure of similarity between the signatures is below a predetermined threshold.

Thus, the match processor 105 may compare the signatures of the current image to those of the samples, and may select one or more of the samples for a matching sample set depending on a suitable match criterion. It will be appreciated that the specific match criterion will depend on the individual embodiment, and in particular will depend on the nature, type and characteristics of the signatures used.

In many embodiments, a similarity or distance measure may be calculated and the match criterion may be a requirement that the similarity or distance measure is below a given threshold. For example, in many embodiments, the sets of signatures may comprise a vector of scalar values, and a distance measurement may be calculated e.g. as a vector distance between the vectors of the current image and of the samples.

The match processor 105 is coupled to medical data processor 111 which is arranged to process the medical data of the samples of the matching sample set. The medical data processor 111 specifically generates medical data for the current image based on the medical data of the matching samples.

As an example, the medical data processor 111 may generate medical data which indicates a possible illness or condition for the patient from which the image was generated. For example, an MRI image may be input to the image receiver 101. The signature processor 103 may accordingly generate a set of signatures for this image and forward them to the match processor 105. The match processor 105 may access the sample store 109 and search through the stored samples to find a set of matching samples as the samples for which the stored signatures are sufficiently close to the generated signatures. The medical data processor 111 may then extract the medical data from these matching samples where the medical data may specifically identify illnesses or conditions that are often associated with the signatures. Specifically, each sample may correspond to an image of a patient, and the medical data for each sample may indicate the diagnosis that was made for the specific patient (e.g. indicating a specific condition or illness, or indeed indicating that the diagnosis was that the patient did not suffer from the suspected illness or condition). The medical data processor 111 may then provide output medical data for the current image which indicates possible illnesses or conditions. The medical data may specifically be metadata in the form of text that specifies one or more diagnosis, together with ancillary imaging and diagnostic data (can be lab samples of blood, etc.)) The different possibilities may for example be ranked in accordance with how frequently they appear in the matching set, and indeed in many scenarios an indication of the likelihood of the specific condition or illness may be included. Thus, by comparing to results of other similar MRI images, the system may process the image to suggest possible illnesses or conditions. For example, if the matching set comprises a large proportion of samples that are associated with e.g. a brain tumor, the output data may indicate that the input image is likely to reflect the presence of a brain tumor.

As a specific example, the system may generate samples of similar images, for a given imaging modality, of patients in the matching (database) unit to the target (distinguishing between target or test images and train images might be useful to conform to standard nomenclature) as well as related metadata.

The system may provide a very effective approach. In particular, the use of compact and effective signatures which are particularly suitable for differentiating and detecting medical issues allows for a very efficient processing. Indeed, it allows for a very efficient communication between the signature processor 103 and the match processor 105 which may in particular enable a substantially bandwidth limited data bus to be implemented. This could allow for fast and rough processing/collecting of related data/signatures in hospital units (e.g., ER) via mobile of devices linked via high bandwidth communication channels.

Also, the identification of suitable matching images while searching through a large data base of images is conventionally a computationally very demanding operation. The matching and comparison is very significantly reduced by basing such a comparison on signatures, and may indeed reduce the computational demand by at least an order of magnitude and typically substantially more. Furthermore, the database requirements may be reduced very substantially as the storage of signatures and associated medical data typically requires much less data to be stored than if the image itself is stored. Thus, an efficient image processing is achieved.

The approach may also allow improved medical data to be generated, and may provide additional assistance to a health professional. Indeed, the approach may allow a search to be performed through larger data bases, and indeed may facilitate storage and distribution of such data bases, thereby providing a better basis for the generation of the medical data. The approach may specifically be suitable for assisting in identifying rarely occurring conditions or illnesses. Human evaluation and analysis tend to (unintentionally) be steered towards the more common causes as it is not possible for a human to be aware of all possible medical conditions. However, as the system allows comparison to a very large number of samples, the data base can also include samples corresponding to very rare conditions and illnesses. Thus, the system may highlight the possibility of a rare illness or condition which typically would not be identified by a purely human assessment.

Furthermore, the approach is suitable for parallelization of the different processes and may in many embodiments be implemented using one or more parallel processors, such as specifically one or more Graphical Processing Units (GPUs). This may be for the purpose of speed-up in the processing—generating signatures for the database (typically offline) or for the matching with database signatures of a target patient's signatures.

In the example of FIG. 1, the signature processor 103 may be implemented in a Central Processing Unit, CPU, whereas the match processor 105 may be implemented by a parallel processor, and specifically as a GPU.

FIG. 2 illustrates a simplified example of an architecture of a CPU and a GPU. As illustrated, a typical CPU may comprise a few Arithmetic Logic Units (ALUs) which may process instructions and data. In addition, the CPU comprises control circuitry (including interface circuitry) as well as a memory cache and some Dynamic Random Access Memory. A CPU is typically capable of executing relatively complex instructions but is not designed for high degrees of parallelization. In the specific example, a maximum of four instructions can be performed simultaneously by the CPU as it contains only four ALUs. The CPU is highly suitable for complex and in particular sequential operations that do not lend themselves to high levels of parallelization.

In contrast, a GPU is typically optimized for parallel operations and comprises a large number of relatively low complexity processing elements which can perform instructions simultaneously. Each processing element is typically capable of processing only a relatively small set of instructions with relatively low complexity. However, for many operations the reduced instruction set is more than made up for by the ability to perform a large number of parallel processes.

The CPU may be suitable for many operations of the apparatus of FIG. 1 including for example implementing a user interface, interfacing with the imaging apparatus etc. It may in many embodiments also be suitable for generating signatures for the medical image. In particular, as the signatures for the image need only be generated once for the image, it may in many embodiments be possible to generate signatures for the image within reasonable times, in particular when the signatures are relatively low complexity and the number of signatures in the set is reasonably low.

However, in embodiments wherein the data base comprises a large number of samples, the match operation may be very computationally intensive as may require a comparison of two large sets of signatures for each sample. However, this operation is highly suitable for parallelization and may therefore be implemented effectively using a parallel processing unit. In such embodiments, the match processor 105 may specifically be implemented as a GPU which provides a large number of parallel processing elements. Indeed, a particular advantage of the approach is that it may be implemented using low cost GPUs which can provide a lot of parallel processing power for low cost. In particular, GPUs developed for e.g. computer graphics may be used to perform the matching operation of the match processor 105.

The match processor 105 may in some embodiments be arranged to in parallel compare different signatures of the set of signatures for the input image to corresponding signatures of the set of signatures of one sample, i.e. different parallel processing elements may compare different signatures of the same sample. Alternatively or additionally, the match processor 105 may be arranged to in parallel compare signatures of the set of signatures for the input image to corresponding signatures of a plurality of samples. Thus, in some embodiments, each of at least some parallel processing elements may be arranged to compare all signatures for the input image to all signatures of one sample. In such cases, different processing elements may process different samples in parallel with each processing element performing the entire signature comparison for one sample.

As an example, the first set of signatures may be generated by the signature processor 103 as a vector of scalar values. For example, the input image may be generated into N blocks and a signature may be generated for each block. E.g., the luminance variation in each block may be determined. The resulting vector may contain a large number of scalar values with each scalar value indicating a variance of a block. The signature vector is then communicated to the match processor 105 over the data bus 107.

In some embodiments, each processing element of the match processor 105 may then proceed to perform a comparison between this vector and the corresponding signature vector retrieved from the sample store 109. Thus, each processing element compares the full input signature vector to the full signature vector for one sample, with different processing elements performing the comparison using different samples, i.e. using different sample signature vectors.

As a specific example, each processing element may determine the square (or absolute value) of the difference between the first scalar value of the input signature vector and the first value of the sample. It may then proceed to determine the square (or absolute value) of the difference between the second scalar value of the input signature vector and the second value of the sample. The process may be repeated for all scalar values of the signature vectors, and a difference measure may be determined as e.g. the average (or sum) of the determined values. In this way, each parallel processing element may generate a difference measure for one sample, with different parallel processing elements generating difference measures for different samples.

In some embodiments, the GPU may then proceed to analyze the resulting difference values to select samples for the matching sample set. E.g., the GPU may select all samples for which the difference measure is below a given level. This matching set may then be fed to the medical data processor 111 together with the associated medical data.

As another example, each of the parallel processing elements may be arranged to generate a difference measure for a single pair of scalar values with different processing elements processing different scalar components of the vector.

For example, a first processing element may determine the square (or absolute value) of the difference between the first scalar value of the input signature vector and the first value of the sample. In parallel, a second processing element may (in parallel/simultaneously) determine the square (or absolute value) of the difference between the second scalar value of the input signature vector and the second value of the sample. A third processing element may determine the square of the difference for the third values etc. A processing element may furthermore add all the generated difference values to generate a difference measure for the sample. This value may be stored, and the GPU may proceed to process the next sample in the same way.

The process may be repeated for all samples resulting in a difference measure being generated for all samples. The GPU may then proceed to select the matching set as described above, such as e.g. selecting the samples for which the difference measure is below a given level.

In some embodiments, the parallelization may be a mixture of such approaches such as e.g. with each processing element processing one pair of scalar values but with two or more samples being processed simultaneously.

The parallel processing may speed-up the match operation very substantially. For example, various practical implementations have shown a speed improvement in the order of a magnitude or more.

It will be appreciated that the described functionality may be distributed in different processing elements and may be implemented differently depending on the specific processing architecture. For example, the distribution of functionality on either side of the band limited data bus may vary for different embodiments, and as such FIG. 1 is merely an example of a possible distribution.

For example, in some embodiments, the GPU may communicate the determined distance measures to the CPU over the bandwidth limited data bus, and the CPU may select the matching set of samples. Indeed, in many embodiments, the medical data processor 111 (and e.g. some functionality of the match processor 105) may be implemented by the same CPU which implements the signature processor 103.

It will also be appreciated that the medical data processor 111 may for example directly access the data base to retrieve medical data for the selected matching set.

In this way, each parallel processing element may generate a difference measure for one sample, with different parallel processing elements generating difference measures for different samples.

In some embodiments, the generation of the first set of signatures may additionally or alternatively be generated by a parallel processing operation.

Specifically, in some embodiments, the signature processor 103 may be partially or fully implemented by parallel processing elements. For example, the signature processor 103 may be implemented by a GPU or a combination of a GPU and a CPU.

In particular, in some embodiments, the signature processor 103 may be arranged to divide the input image into a plurality of image segments/blocks (where the image segments may be two dimensional or three dimensional as appropriate). This division may for example be a fixed division into fixed blocks. For example, an 800×800×700 voxel three-dimensional image may be divided into 100×100×100 voxel segments or blocks. Thus, the image may automatically be divided into 392 segments of a fixed size.

The signature processor 103 may comprise parallel processing elements that are used to generate a signature for each of these segments but with each processing element processing only a subset of the 392 segments. Indeed, if the signature processor 103 comprises more than 392 parallel processing elements, each processing element may process one segment to generate one signature. For example, each parallel processing element may determine the luminance variation for the segment. In this way, a set of 392 signatures may be generated very quickly.

In the example, the division into image segments is not dependent on image properties of the first image but is rather a blind segmentation. This may reduce complexity and may in many embodiments be useful for generating signatures of particular relevance for medical processing. For example, a density of specific events is an efficient indicator for many illnesses. In such embodiments, the segmentation into equally sized segments followed by a detection of the number of objects corresponding to the events (e.g. abnormal cells) may generate a local signature directly indicative of the density of abnormal cells. Thus, a simple count in each segment may generate a local signature relevant for detection of a possible illness.

In some embodiments, the segmentation may be dependent on the image characteristics. As a low complexity example, the signature processor 103 may be arranged to determine an image segment of the segments based on the image properties, with the determined size then being constant, i.e. being applied to all segments.

The retrieved medical data may be used by the medical data processor 111 to provide additional information to a health professional. As a simple example, the medical data may be simply be presented to the health professional. For example, an output may be generated which reflects the diagnosis associated of each of the identified samples. The list of diagnoses for patients for whom images closely resembling the current image have been generated may be used as an input of possible diagnoses that the health professional should consider further. This may be particularly helpful in allowing rare conditions to be detected, and indeed may allow conditions that the heath professional is not even aware of to be detected and considered.

In some scenarios, the degree of matching for the samples may also be provided. For example, a list which for each sample indicates the diagnosis and how closely the sample resembles the current image may be output.

In many embodiments, the medical data may be processed by the medical data processor 111. For example, the data may be collated such that all samples corresponding to the same diagnosis are combined. This approach may for example be used to generate a list of diagnoses together with an estimated probability of the diagnoses being appropriate for the current image may be provided. If many samples of a given diagnoses are found with each sample being a close match, then a high probability is indicated. If only one sample with a relatively low match measure is found for a given diagnosis, then a low probability is indicated.

It will be appreciated that many other forms of medical data may be derived and may be used differently. For example, the data may simply be used to generate health statistics and the data for the individual image may not be presented to anybody.

As another example, the medical data may be used to further process the image, or e.g. to modify the visual appearance of the image when being presented. For example, the medical image may indicate that in similar images, a given characteristics was found to be particularly suitable for indicating whether a the patient suffered from a given condition or not. For example, the shape of a particular image object may be indicated to be important with the medical data further indicating the characteristics of the image objects. The apparatus may then identify image objects in the current image which have similar characteristics and highlight these image objects when displaying the image (e.g. together with text describing the importance and what characteristics to look out for).

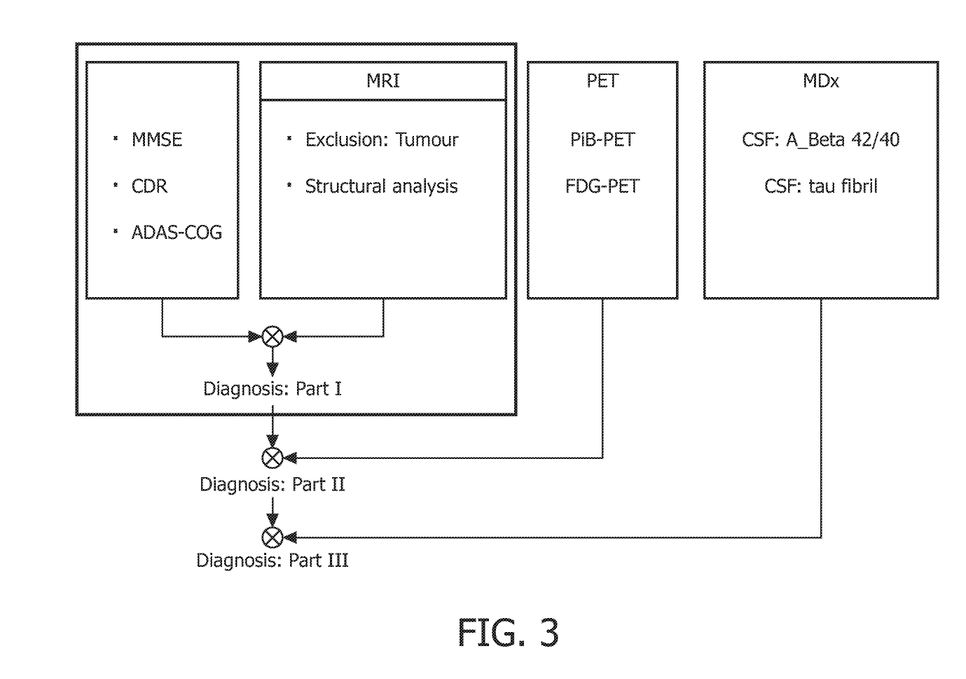

As a specific example of a possible use of the medical data, the apparatus may assist in detecting whether a patient suffers from Alzheimer's disease. FIG. 3 illustrates the standard procedure for the diagnosis of Alzheimer's disease (or more generally neurodegenerative diseases) as determined by the American Association of Neurology—2009 guideline set. In the figure, the terms PiB-PET and FDG-PET are PET contrast agents. PiB is the Pittsburgh compound based on Carbon 11, and FDG measures the sugar level in the brain. MDx is basically analysis of spinal (CSF) fluid extracted from the spine.

It will be appreciated that many different approaches for generating, processing and comparing signatures may be used depending on the preferences and requirements of the individual embodiment and application. In the following, various advantageous examples will be provided but it will be appreciated that the invention is not limited to these specific approaches.

In many embodiments, the signature processor 103 may be arranged to generate local signatures which represent local image information. Thus, rather than a signature reflecting a property of the image as a whole, a local signature reflects only the image in a subset of the image, such as in a specific segment or block.

As described previously, the signature processor 103 may divide the image into segments and determine one or more signatures for each segment by considering only image properties in the individual segment. Thus, such signatures reflect only local image characteristics, namely the characteristics within the specific segment.

Many signatures may allow at least a partial reconstruction of a local image area. For example, a signature may indicate a variance and an average luminance. Such a segment may be approximated by a segment with the same average luminance and random variations corresponding to the variance.

As another example, the signature processor 103 may be arranged to generate a wavelet representation of e.g. the luminance of the segment. This wavelet representation may then be truncated and a signature vector may be generated to correspond to the remaining wavelet coefficients following the truncation. Thus, in this example, a signature vector may be generated for each segment and the set of signatures for the image may be a two-dimensional matrix with each row (or column) corresponding to the vector. Such a wavelet representation may provide a very compact representation of the image characteristics. The approach may allow the comparison by the match processor 105 to be based directly on the visual impression provided by the image rather than on derived features. At the same time, it allows for a relatively low complexity comparison that is furthermore suitable for parallelization. Thus, the approach may provide a practical approach for detecting samples corresponding to images that “look” similar to the current image. Thus, stored medical data for images that look like the current image can be identified and extracted, and e.g. be displayed to a health professional.

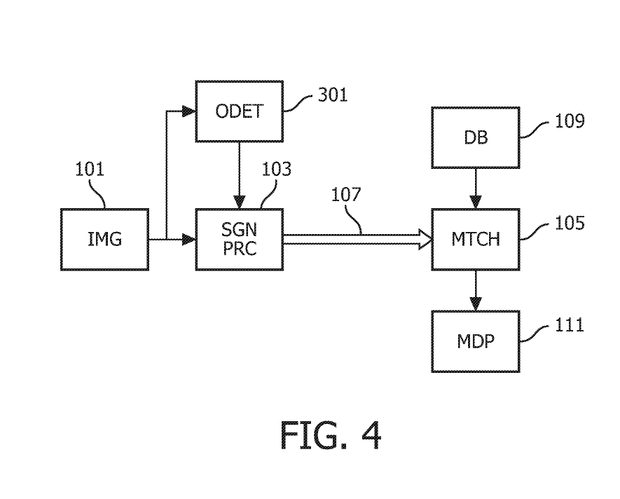

In many embodiments, signatures, and in particular local signatures, are generated on the basis of image objects in the image. An example of an image processing apparatus for some such embodiments is shown in FIG. 4. The apparatus corresponds to that of FIG. 1 but further comprises an image object detector 301 which is arranged to detect image objects in the image.

The image object detector 301 may be arranged to detect image objects using any suitable algorithm or approach. It will be appreciated that many image object detection algorithms exists and will be known to the person skilled in the art, and that any suitable approach may be used without detracting from the invention.

Most image object detection algorithms are based on detecting a difference in image characteristics between different regions. For example, transitions in luminance and/or color may be used to detect borders of various image objects, and specifically image objects may be found as contiguous regions which have image properties that are sufficiently similar.

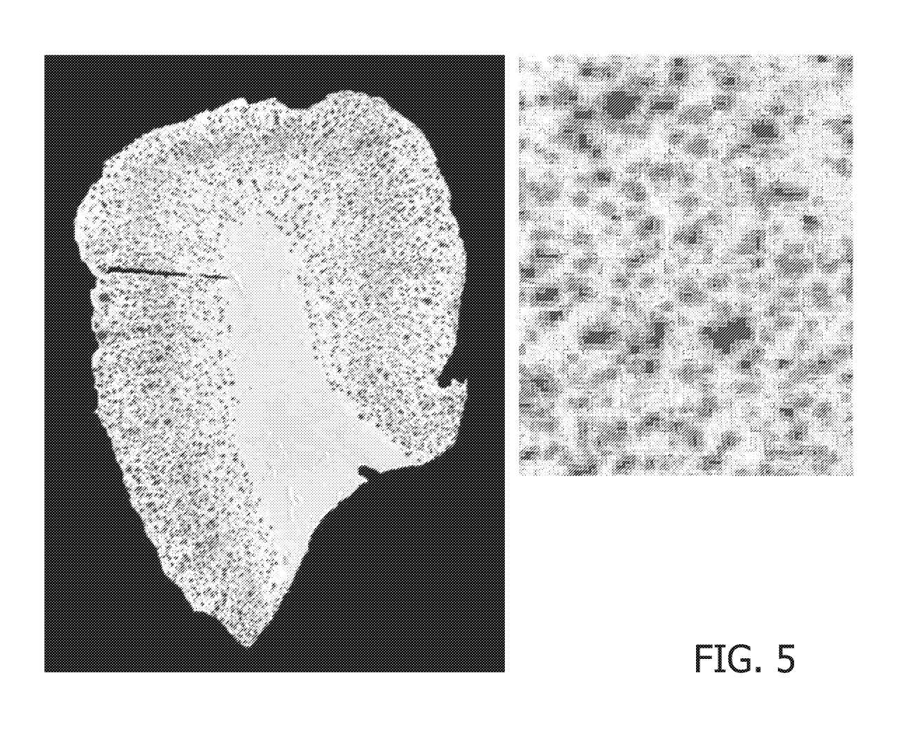

As an example, FIG. 5 illustrates a two-dimensional image of an ex-vivo patho-histological sample with Amyloid-Beta 42 staining. The Amyloid-Beta 42 deposits show up as dark spots on a lighter background. These Amyloid-Beta 42 deposits provide an indication of potential Alzheimer's disease (AD). Not all elderly with these deposits have AD but it may be a good indication of the possibility thereof. A diagnosis of AD may be determined based on a combination with other information relating to focal brain tissue atrophy of the temporal lobe, in particular of the hippocampus area, and neuropsychiatric tests indicative of memory, plus other impairments. By analyzing these issues, it is often possible to diagnose the probability of the patient suffering from AD.

In processing such an image, the image object detector 301 may be arranged to detect the image objects corresponding to the Amyloid-Beta 42 deposits. This may for example be done by the image object detection algorithm finding image objects corresponding to contiguous regions that are sufficiently dark and which have a size within a given interval.

The image object detector 301 feeds the information of the detected image objects to the signature processor 103 which proceeds to determine signatures based on the image objects.

It will be appreciated that many different signatures may be generated. As an example, the signature processor 103 may divide the image into segments of a predetermined size and may then determine a signature for the segment as the number of image objects within the segment. For example for the image of FIG. 5, the number of Amyloid-Beta 42 deposits in each segment may be used as a local signature for the segment. Thus, a set of signatures indicating the number of image objects, and for the image of FIG. 5 of Amyloid-Beta 42 deposits, may be generated and fed to the match processor 105. The match processor 105 may then compare to samples of the data base stored in the sample store 109. For example, the match processor 105 may find samples which have roughly the same number of image objects per segment, or may in more advanced comparisons identify samples which have similar spatial distributions across the image. For example, the current image may have a large number of image objects in a relatively small area with few image objects in segments outside this area. Samples corresponding to similar images may be found in the data base while differentiating to other samples corresponding to images that may have the same average number of image objects in each segment but with these being more equally distributed throughout the image. Thus, in the example of FIG. 5, the apparatus may use this approach to find samples that correspond to similar distributions of Amyloid-Beta 42 deposits. Accordingly, the apparatus can extract medical data which corresponds to similar distributions of Amyloid-Beta 42 deposits, and thus may provide medical data that has been found relevant for similar images. Such information may for example indicate the possibility or probability that the patient suffers from Alzheimer's disease.

In some embodiments, the spatial characteristics of one or more of the image objects may be used to generate signatures. For example, a subset of image objects may be selected, for example one image object in each segment. The image object may then be analyzed to provide a signature. For example, the shape, area, or volume of the image object may be identified. This may in many embodiments be very suitable for determination of medical information.

In the application using histological images For example, when considering e.g. AD patients, the approach may identify image objects corresponding to the Amyloid Beta 42 deposits. The system may then proceed to determine the size, position, and orientation of individual Amyloid Beta 42 deposits as well as the shape and other signatures. Based on this, the system may proceed to determine the statistical properties of the signatures. These statistical properties can then be compared to similar properties/signatures of previously processed histological images in the database. One type of Amyloid Beta 42 deposit is called “core” and they are usually darker, larger in size, and have a more circular shape.

FIG. 5 illustrates an example of detection results for the Amyloid Beta image object detection where the dark spots correspond the Amyloid Beta deposits.

In the case of AD diagnosis, and more generally, the diagnosis of brain neurological diseases, the diagnosis may be based on the detection of: (i) focal (regional/local) tissue atrophy—the temporal decrease of brain tissue, which is substituted by cerebrospinal fluid (CSF). For example, for the case of AD, the ventricle increase and the temporal lobe atrophy are standard visual markers. These may be seen as an increase of “dark” pixels or CSF in e.g. some (T1-weighted) MRI images. The diagnosis may further be based on (ii) memory, attention, executive and motor function functions increased impairments (in particular memory as the first function to be affected) which is verified via neurophsychiatric tests (see FIG. 3); and (iii) the in vivo test with PiB-PET of the deposits of Amyloid-Beta 42. Combined, these three sets of features can lead to a strong indication of AD.

The system may process such images to e.g. determine the likelihood of the patient suffering from AD, and this may be used as the basis for or in combination with analysis of the memory, attention, executive and motor function functions to determine a diagnosis.

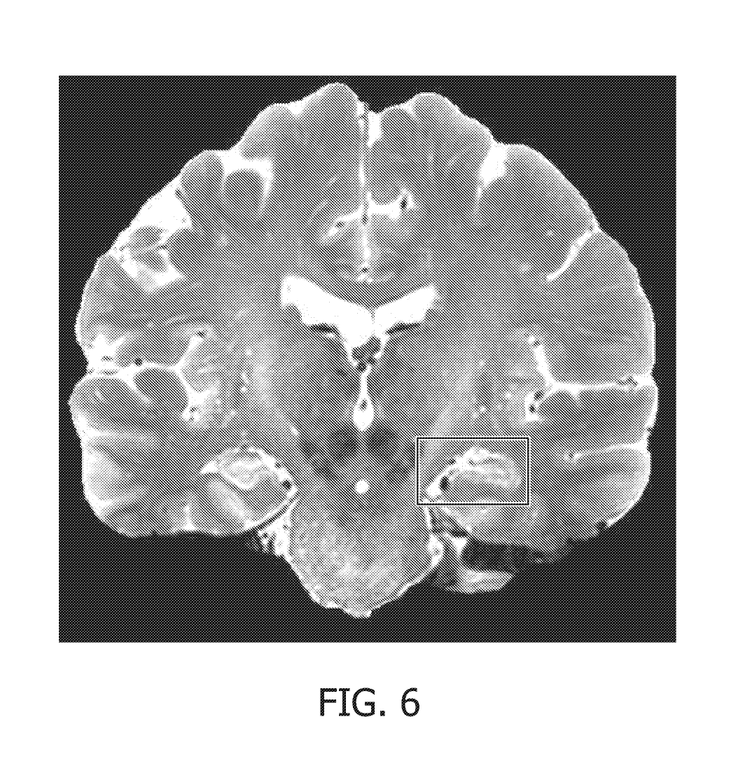

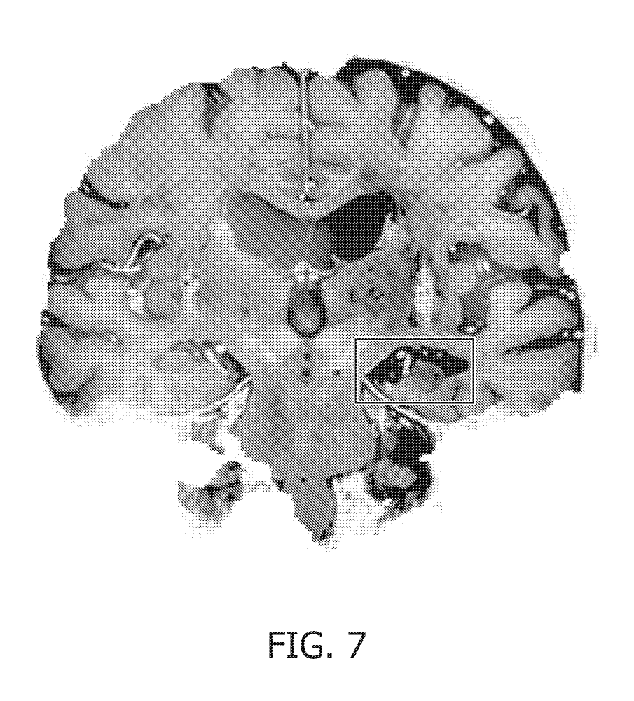

As another example, FIG. 6 illustrates a 7T T2-weighted coronal MRI scan of a healthy individual and FIG. 7 illustrates a 7T T2-weighted coronal MRI scan of a diseased subject. As can be seen, the healthy individual has little CSF (white pixels) while the individual has a lot of CSF. This specifically indicates the hippocampus (highlighted by a bounding box) has shrunk (focal atrophy). The system may accordingly identify white image objects in such images and generate signatures describing the size and proportion of such image objects. By comparing these signatures to corresponding signatures of samples in the database, MRI scans similar to that of the current individual can be found, and the medical data associated with these samples can be extracted. Thus, medical data which has been stored for MRI scans which exhibit similar amounts of focal atrophy can easily be identified and extracted. For example, based on the size and proportion of the CSF image objects, the system may determine a probability of the patient suffering from the condition. It is worth noting that the approach can be used for both in-vivo and ex-vivo data. E.g. in-vivo data may include MRI, PiB-PET, neuropsychiatric tests etc. and ex-vivo may include neuro patho-histological tests in the case of AD or related brain diseases. For cancer, there may be MRI, CT, PET, etc. images plus pathohistological tests all in-vivo.

For each object, corresponding to a potential tumor, the signature processor 103 may determine an area or volume and use this as a signature. Alternatively or additionally, it may determine a shape parameter and use this as a signature, such as e.g. an indication of how circular or irregular the image object is.

The match processor 105 may accordingly find corresponding signatures in the data base, and thus find medical data relating to patients who exhibited potential tumors of similar size, and or shape. Specifically, such medical data can indicate whether the tumor of the patient for which the sample was generated was found to have a benign or malignant tumor. Indeed, the size and in particular shape of tumors have been found to provide a strong indication of the nature of the potential tumor, and thus the apparatus may allow for an automated comparison and detection of samples corresponding to patients that exhibit very similar characteristics as the current patient.

As another example, a signature may be generated for each image object based on a luminance or chromaticity of the image object. E.g. in the example of FIG. 5, the signature for an image object may be generated to refer to how dark the image object is. This may be an indication of how likely the dark spot is to be an Amyloid-Beta 42 deposit rather than a random dark area. For color images, the same approach may be applied to the color. Also, in some embodiments, the texture, i.e. the color and/or brightness variations, across an image object may be quantified and used as a signature.

In some embodiments, the position, orientation or pose (position and orientation) of the image objects may be used to generate signatures that can be particularly suitable for detecting samples corresponding to images which have similar medical characteristics. For example, as previously described, the characteristics of image objects corresponding to Amyloid-Beta deposits may be determined and analyzed to generate signatures based on these features of the image objects.

In some embodiments, signatures may specifically be generated from properties of the object boundary. For example, as previously described, the shape of the image object may be suitable to reflect characteristics which are likely to be particularly indicative of medical conditions, and therefore particularly suitable for finding samples which correspond to similar medical conditions and which accordingly can provide medical data of particular relevance to the current patient.

As another example, for some medical conditions, the surface of the object resulting in the image object may have characteristics which are particularly indicative of medical conditions. For example, a signature may be generated which reflects whether the boundary of the image is smooth or rough. A signature may thus be generated which indicates a degree of roughness/smoothness of the outside of the image object, and this may be used to find samples with similar characteristics.

In many embodiments, one or more of the signatures may be generated in response to a moment of the image object.

Specifically, given a density distribution f(x,y) where x, y are the pixel coordinates of an image object in a two dimensional image, moment p,q may be determined from

$${m}_{pq} ≡ {\int }_{- ∞}^{+ ∞} {\int }_{- ∞}^{= ∞} {x}^{p} {y}^{q} f ( x , y ) d x d y$$

or in the sampled domain:

$${m}_{pq} ≡ {\sum }_{y = 0}^{M - 1} {\sum }_{x = 0}^{N - 1} {x}^{p} {y}^{q} f ( x , y )$$

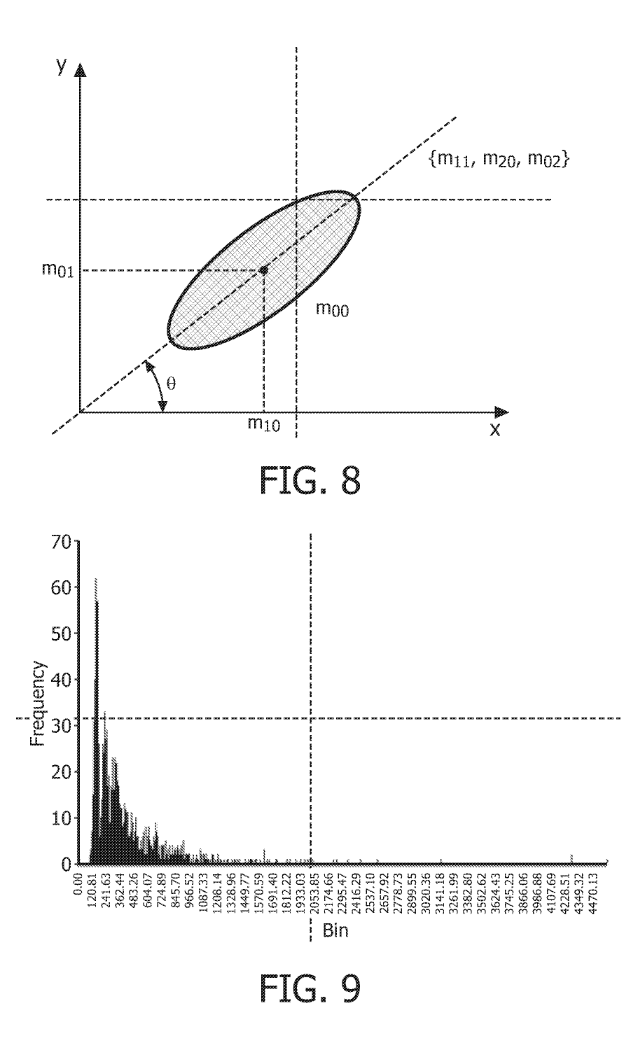

The various moments may be indicative of e.g. the area, volume, orientation of the image objects etc. as illustrated in FIG. 8. In many embodiments, and in particular in embodiments where only very few image objects are considered, the number of moments used for the image object may be relatively high, such as e.g. all moments for which p and q are between 0 and 5. Indeed, in some embodiments the first set of signatures may consists of such a set of signatures, i.e. where the signatures are generated as the moments. The moments provide a very compact yet quite accurate representation of the geometric characteristics of the image object and therefore provide an efficient approach for compacting information about the image to data that is suitable for communication over a bandwidth limited link, as well as for finding samples that exhibit similar characteristics.

It will be appreciated that in many embodiments, a signature may be generated for one image or for a group of image objects. For example, the average darkness of the detected image objects in a segment may be used as a signature for the entire segment rather than having individual signatures for individual image objects.

Also, in some embodiments, a signature may be included for each image object, and indeed in some scenarios there may only be one image object detected in each image, such as an image object corresponding to a potential tumor. In such examples a plurality of parameters may be determined for that image object and used as a set of signatures. E.g. the set of signatures may comprise the size, color, luminance, texture, shape, orientation and moments of one image object.

In other image objects, a plurality of image objects may be detected and one signature may be generated for each image object. For example, a set of signatures comprising the size of the detected image objects may be generated. In some embodiments, the set of signatures may be generated to comprise a subset of the total number of image objects. For example, a signature vector consisting of a property of a fixed number of image objects may be generated. These image objects may then be selected in accordance with any suitable criterion. For example a set of signatures may be generated as the size and luminance of the 1000 largest detected dark image objects in an image. This set of signatures may then be fed to the match processor 105 which can proceed to find samples corresponding to images for which the 1000 largest dark spots had similar characteristics. This may allow a very efficient detection of relevant information while allowing a manageable computational resource demand.

In the previous examples, the generated signatures were local signatures generated to reflect the image properties in a limited region. The signatures typically reflect a characteristic of one property in a local region.

However, in other embodiments, more complex signatures may alternatively or additionally be generated. For example, signatures may be generated as a combination of the local signatures.

For example, local signatures may be generated for each image object to indicate the size of the image object. The signatures may then be processed to determine a statistical distribution of the signatures for the whole image. For example, a histogram reflecting how many image objects were found of a given size (interval) may be generated. A combined signature indicative of properties of a plurality of image objects can be generated. For example, signatures describing the histogram may be generated. E.g. a scalar value may be generated for each size interval of the histogram indicating the proportion of image objects in that interval.

For example, FIG. 9 illustrates an example of a histogram of the moment M₀₀ for image objects corresponding to deposits in an Amyloid-Beta 42 stained histology image. A set of signatures describing the histogram may then be generated and transmitted to the match processor 105 where it can be used to compare to the signatures of the samples to find samples that have a similar distribution.

In some embodiments, the combined signatures may be generated to reflect a correlation between signatures. For example, a signature may be generated which reflects how similar the size of the image objects corresponding to Amyloid-Beta 42 are.

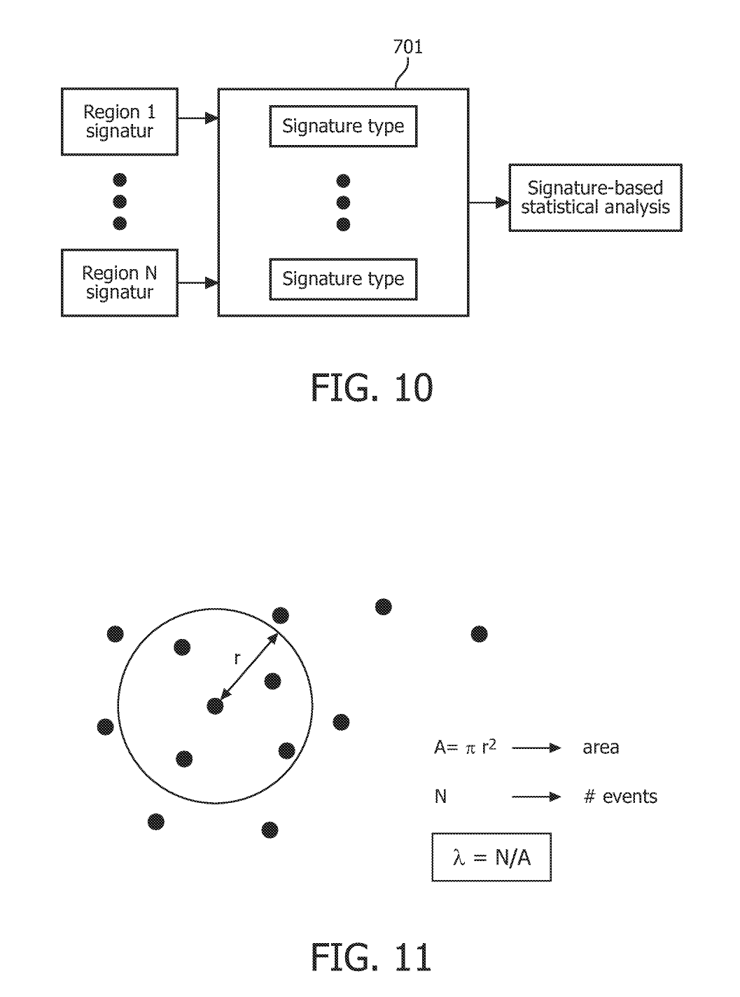

Thus, in many embodiments, a combined signature may be given which provides a statistical measure of properties of the image, such as statistical properties of the detected image objects. FIG. 10 illustrates an example of the approach. Initially, local signatures may be generated for different regions, with each region e.g. corresponding to a segment of predetermined size or an image object. The signatures may then be processed in a signatures classification module 701. This signatures classification module 701 may for example cluster similar signatures, e.g. similar sizes, contour sizes, contour shapes, moments etc may be clustered and grouped together. Each cluster may then be processed to generate statistical properties and/or the statistical properties corresponding to the clustering may be used to generate a signature set.

In some embodiments, one or more of the signatures may be determined based on a comparison of a property of the image objects to a reference for the property. Such an approach may be particularly attractive as it allows a focus on abnormalities which are typically indicative of a medical condition.

For example, a feature may have a tendency to have a substantially spherical shape in a healthy individual. However, in case of an illness, the feature may deviate substantially from the spherical shape, e.g. due to an internal growth.

In such an example, the detected image objects may be first be evaluated to determine how spherical they are. For example, a measure reflecting the degree to which the individual image objects deviate from a spherical shape may first be determined. A histogram showing the distribution of the deviations may then be generated, and a signature set describing the histogram can be generated. This signature set may then be transmitted to the match processor 105 which can use it to find samples for which similar signatures have been stored. Thus, the approach allows the apparatus to identify samples which have a similar distribution of abnormalities. The medical data for these samples may for example include data defining the diagnosis for the patient from which the data base sample/entry was generated, the treatment, how the patient responded to the treatment etc. This data may e.g. be displayed to a health professional which can use the relevant data when diagnosing the patient and finding suitable treatment.

In some embodiments, the signature processor 103 may for example generate an average and variance of the deviation from the reference values and use these values as signatures. In such an approach, the values may e.g. be generated for different areas (volumes) of the image such that a spatial distribution of the average and variance in the deviation from the normal characteristics is represented.

Thus, in many embodiments, the statistical deviation from the normal non-pathological characteristic may be determined and used to find suitable samples in the database.

In some embodiments, the deviation from the reference may be used to select a subset of image objects used to determine signatures. As an extreme example, all image objects may be compared to a reference and the image object that deviates most may be identified. This image object may then be characterized by a set of signatures, such as e.g. a range of moments. The set of signatures may be communicated to the match processor 105 and used to find suitable database samples. This may be advantageous in many scenarios where a suspected illness only give rise to a single abnormality. For example, the approach may allow a single tumor to be identified and characterized by the signatures. Samples corresponding to similar tumors may then be identified and the medical data provided for these samples can be extracted.

In many embodiments and for many applications, a particularly suitable set of signatures may be generated to indicate a local density variation of image objects that meet a specific criterion. For example, in the image of FIG. 5, image objects corresponding to darker spots may be generated. These image objects may then be evaluated to determine whether they correspond to Amyloid-Beta 42 deposits or not. For example, only image objects which are sufficiently dark and have a size within a suitable interval may be detected. A local density of these Amyloid-Beta 42 deposits can then be determined for a range of positions and thus the spatial distribution of this density can be determined.

For example, as shown in FIG. 11, the number of events, in this case Amyloid-Beta 42 deposits, within a given radius r may be determined for a given position. This value (or the density value) may then be used as one signature. The same approach may then be repeated for another position to generate a second position. By repeating this approach e.g. for a grid of positions covering the image, a set of signatures reflecting the spatial distribution of events (Amyloid-Beta 42 deposits) over the image can be generated. Such a set of signatures may thus reflect e.g. whether events are equally distributed across the organ, whether events are concentrated in a small area, whether events are clustered around a plurality of areas, whether the concentration is higher towards the boundary of the organ than the center etc. Such a spatial distribution of events may provide a particularly good indication of medical conditions in many cases, and thus is particularly suitable for finding samples reflecting similar conditions.

In many embodiments, the apparatus may be a fully automatic data processing system. For example, an input of a medical image may be provided such as an MRI or neuro-pathological histological image. A data base is furthermore provided which comprises medical data, such as reference data provided from MRI brain atlases. The output of the system may be medical data which has been found relevant for images that provide a medical match to the input image.

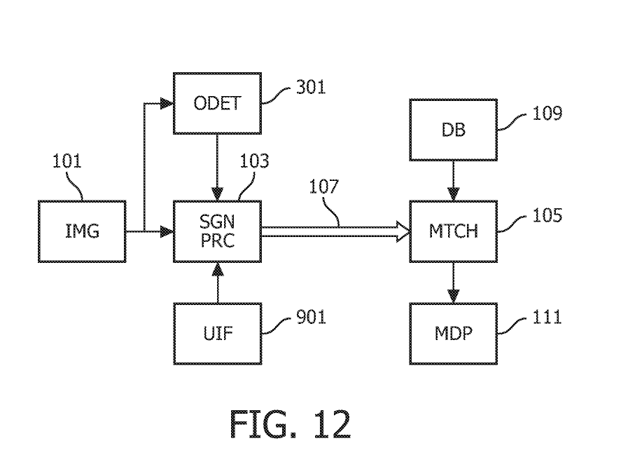

In some embodiments, the apparatus may be semi-automatic and the operation may be partly based on a user input. FIG. 12 illustrates an apparatus in accordance with such an approach. The apparatus corresponds to the apparatus of FIG. 4 but further comprises a user interface 901 for receiving user inputs.

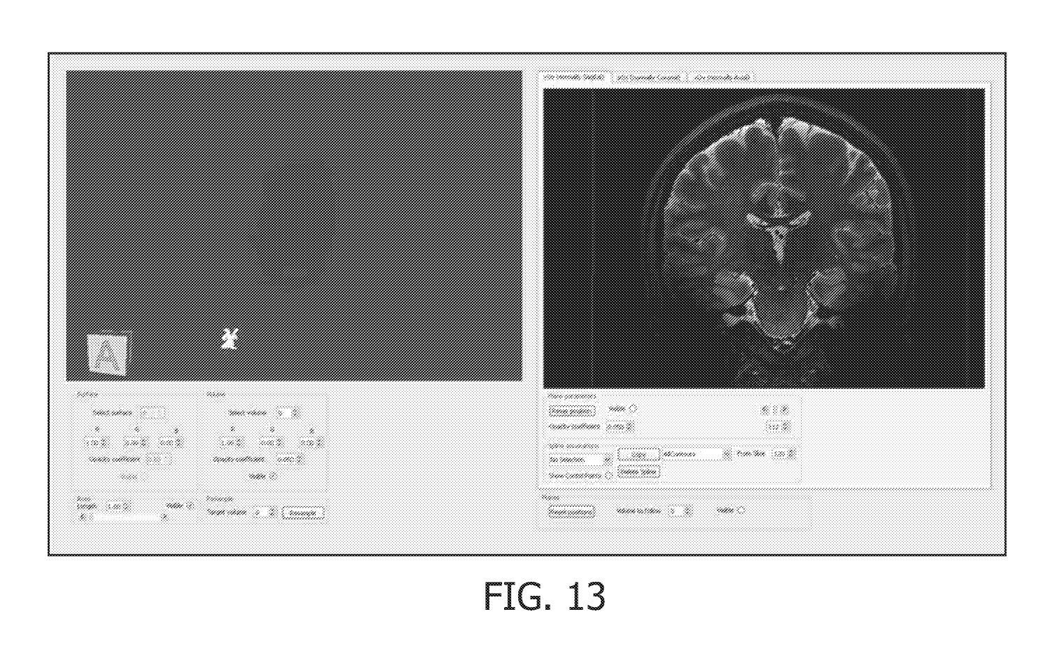

The user input may specifically be used to generate one or more of the signatures. Thus, the signature generation can be guided by a user input which may for example be provided by a health professional. For example, the approach can be used by a specialist (neurologist, histo-pathologist, neuro-radiologist, etc.) to trace the boundaries of objects in organs. For example, the specialist may simply draw contours on a screen using a suitable input device, and the contours may then be used to determine the image objects for which signatures are subsequently generated. FIG. 13 illustrates an example of a graphical user interface that can be used by a specialist to trace the boundaries of areas considered to be of particular interest for the medical evaluation.

The approach may for example make use of splines that interpolate between landmark points chosen by the annotator. After interpolation, being it of 2-D points on the object boundary or on the 3-D surface of the object boundary, a continuous contour or surface can be computed by the annotation system.

In some embodiments, the apparatus may be arranged to update the data base based on the current image. This may allow the data base to continuously be updated and improved.

For example, the apparatus may be arranged to add a sample for the current image to the set of samples stored in the sample store 109. Thus, a new sample may be added which comprises the set of signatures generated for the current image. In addition, medical data for the image may be stored. This medical data may for example be entered manually by a health professional or may e.g. be generated from the medical data that was extracted from the matching samples.

In many embodiments, the system may be implemented as a distributed system wherein different parts may be located remotely from each other. In particular, the approach is very suitable for networked implementations. For example, in many scenarios it is highly desirable to have a centralized approach wherein the data base and functionality for finding matching samples in the data base are positioned at a remote central position, whereas a number of user stations are distributed at suitable positions for individual users. For example, a number of hospitals may each have one or more user stations which all utilize the data stored in the same data base. However, such a system is typically limited by the data communication capacity of the network connecting the user stations to the centralized server.

Indeed, processors are becoming extremely fast and able to perform huge amounts of calculations on data, and increasingly the data communication between processing units is therefore becoming the bottleneck limiting the performance of the system. This is often the case for networked systems where different processors are remote from each other. However, it may also be an issue for systems wherein two different processors are close together, such as e.g. for a two processor computer.

In the described approach such bottlenecks may be mitigated by using a highly efficient representation of relevant data. In particular, the use of signatures may substantially reduce the amount of data that needs to be communicated.

For example, in some embodiments the signature processor 103 may be implemented remotely from the match processor 105 with the two being interconnected via a communication network, such as e.g. a Local Area Network (LAN) or e.g. the Internet.

In such an example, the user station may process the image to generate signatures. Subsequently, the signatures (and typically substantially only the signatures) may be communicated to the central server which contains the match processor 105 and the sample store 109 which stores the data base. The central server can then proceed to perform the match operation and extract the relevant medical data for the matching samples. This medical information can then be transmitted to the user station via the communication network. Thus, no specific image data needs to be communicated. This may provide a very efficient operation.

It will be appreciated that the above description for clarity has described embodiments of the invention with reference to different functional circuits, units and processors. However, it will be apparent that any suitable distribution of functionality between different functional circuits, units or processors may be used without detracting from the invention. For example, functionality illustrated to be performed by separate processors or controllers may be performed by the same processor or controllers. Hence, references to specific functional units or circuits are only to be seen as references to suitable means for providing the described functionality rather than indicative of a strict logical or physical structure or organization.

The invention can be implemented in any suitable form including hardware, software, firmware or any combination of these. The invention may optionally be implemented at least partly as computer software running on one or more data processors and/or digital signal processors. The elements and components of an embodiment of the invention may be physically, functionally and logically implemented in any suitable way. Indeed the functionality may be implemented in a single unit, in a plurality of units or as part of other functional units. As such, the invention may be implemented in a single unit or may be physically and functionally distributed between different units, circuits and processors.

Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognize that various features of the described embodiments may be combined in accordance with the invention. In the claims, the term comprising does not exclude the presence of other elements or steps. Under the definition of animal we consider inter alia pets like cats and dogs, breeding animals like race horses or milk cows, wild animals like birds, etc.

Furthermore, although individually listed, a plurality of means, elements, circuits or method steps may be implemented by e.g. a single circuit, unit or processor. Additionally, although individual features may be included in different claims, these may possibly be advantageously combined, and the inclusion in different claims does not imply that a combination of features is not feasible and/or advantageous. Also the inclusion of a feature in one category of claims does not imply a limitation to this category but rather indicates that the feature is equally applicable to other claim categories as appropriate. Furthermore, the order of features in the claims do not imply any specific order in which the features must be worked and in particular the order of individual steps in a method claim does not imply that the steps must be performed in this order. Rather, the steps may be performed in any suitable order. In addition, singular references do not exclude a plurality. Thus references to “a”, “an”, “first”, “second” etc do not preclude a plurality. Reference signs in the claims are provided merely as a clarifying example shall not be construed as limiting the scope of the claims in any way.

1. An apparatus for determining medical data for an image, the apparatus comprising:
a receiver configured to receive the image which represents characteristics of a part of a human or animal body;
a signature unit configured to determine an image associated set of signatures from the image;
a sample store configured to store a set of samples, each sample comprising a sample associated set of signatures and the medical data;
a matching unit configured to determine a set of matching samples based on a comparison between the image associated set of signatures and the sample associated set of signatures; and
a decision unit configured to determine the medical data for the image based on the set of matching samples.

2. The apparatus of claim 1, wherein at least some signatures of the image associated set of signatures are local signatures which represent local image information.

3. The apparatus of claim 2 wherein the signature unit is configured to divide the image into a plurality of image segments, and wherein the signature unit comprises a processor having a plurality of processing elements, each of which is configured to process a subset of the image segments to determine the local signatures for the image segments.

4. The apparatus of claim 3, wherein a division into image segments is not dependent on image properties of the image.

5. The apparatus of claim 3, wherein the signature unit is further configured to determine an image segment size for the image segments in response to image properties of the first image.

6.-10. (canceled)

11. The apparatus of claim 1, further comprising:
an image object detector configured to detect at least one image object in the image; and
wherein the signature unit is configured to determine at least one signature of the image associated set of signatures in response to a property of the image object.

12. (canceled)

13. The apparatus of claim 11, wherein the at least one signature is determined in response to a moment of the image object.

14. The apparatus of claim 11, further comprising:
an image object detector for detecting at least one image object in the first image; and wherein the signature unit is arranged to determine at least one signature of the image associated set of signatures in response to a property of the image object, wherein the signature unit is configured to determine at least one signature of the image associated set of signatures in response to a comparison of the property to a reference.

15. The apparatus of claim 14, wherein the signature unit is configured to determine at least one signature in response to a statistical deviation of an image property relative to a reference property for a plurality of image objects.

16.-19. (canceled)

20. The apparatus of claim 1, wherein the signature unit is configured to detect image objects meeting a criterion, at least one signature of the image associated set of signatures is generated in response to a local density variation of the image objects meeting the criterion.

21-23. (canceled)

24. A method of determining medical data for an image, the method comprising:
receiving an image representing characteristics of a part of a human or animal body;
determining an image associated set of signatures from the image;
providing a set of samples, each sample comprising a sample associated set of signatures and the medical data;
determining a set of matching samples based on a comparison between the image associated set of signatures and the sample associated sets of signatures; and
determining the medical data for the image based on the medical data associated with the set of matching samples.

25. (canceled)

26. The apparatus of claim 1, wherein the apparatus is configured to use the medical data determined in response to the medical data comprised in the samples to further process the image.

27. The apparatus of claim 1, wherein the decision unit is configured to collate samples, such that the samples corresponding to a same diagnosis are combined.

28. The apparatus of claim 1, wherein the signature unit is arranged to divide the image into a plurality of image segments and to determine the signature for each segment as the number of image objects within the segment; and the matching unit is configured to identify samples from the set of samples which have similar spatial distributions of signatures across the image.

29. The method of claim 24, comprising using the medical data determined in response to the medical data comprised in the samples to further process the image.

30. The method of claim 24, comprising collating samples, such that the samples corresponding to a same diagnosis are combined.

31. The method of claim 24, wherein at least some signatures of the image associated set of signatures are local signatures representing local image information, the method further comprising:
dividing the image into a plurality of image segments;
determining the signature for each segment as the number of image objects within the segment and;
identifying samples from the set of samples which have similar spatial distributions of signatures across the image.

32. A non-transitory computer-readable medium having one or more executable instructions stored thereon, which when executed by a processor, cause the processor to perform a method for determining medical data for an image, the method comprising:
receiving an image representing characteristics of a part of a human or animal body;
determining an image associated set of signatures from the image;
providing a set of samples, each sample comprising a sample associated set of signatures and the medical data;
determining a set of matching samples based on a comparison between the image associated set of signatures and the sample associated sets of signatures; and
determining the medical data for the image based on the medical data associated with the set of matching samples.
